(19) United States
(12) Patent Application Publication
(10) Pub. No.: US 2016/0205357 A1
(43) Pub. Date: Jul. 14, 2016

(54) Viewing system for bicyclists

(71) Applicant: Allan M Pepito, Belmont, CA (US)

(72) Inventor: Allan M Pepito, Belmont, CA (US)

(21) Appl. No.: 14/594,105

(22) Filed: Jan. 10, 2015

(51) Int. Cl. H04N 7/18; B62J 29/00

(52) U.S. Cl. CPC H04N 7/185; B62J 29/00

(57) ABSTRACT

A method of presenting a desired view of external surroundings to a rider of a bicycle attaches a mirror to a smart device) at a position and orientation relative to a camera integrated into the smart device such that light from external surroundings incident on the mirror is reflected onto the camera, and activates an application on the smart device causing images captured by the smart device to be displayed on a display screen of the smart device. The smart device is removably attached to the bicycle such that the smart device display screen is visible to the rider when the rider is in a substantially horizontal riding position on the bicycle.

### BACKGROUND

The approximately horizontal torso position chosen by riders of road bicycles for riding speed and efficiency does not allow the rider to have a good view of the road ahead, unless the rider's head is deliberately lifted up, out of alignment with the back. Sustaining this lifted-head position for a prolonged period, or even repeatedly attaining and then releasing this position, can result in discomfort and fatigue of muscles of the upper back, neck and/or shoulders. However, whenever the rider takes their eyes off the road to achieve a more natural resting position, but continues to move forward, awareness of the road and traffic or general terrain conditions about to be encountered is lost, and safety is clearly compromised.

It is therefore desirable to provide a method for presenting a view of the environment in front of the road bicycle, which the rider in the horizontal riding position can see without having to raise their head. Ideally, the method would not require the rider to carry special equipment or to attach additional heavy or bulky items to the bicycle. An additional attractive feature would be the option of similarly viewing the environment in other directions, such as behind the bicycle, where, for example, another rider may be in the process of making an overtaking maneuver.

### SUMMARY

The present invention includes a method of presenting a desired view of external surroundings to a rider of a bicycle. The method comprises attaching a minor to a smart device such as a smartphone, a tablet, a mini-tablet, or similar electronic device, such that light from external surroundings incident on the mirror is reflected onto a camera integrated into the smart device, and activating an application on the smart device causing images captured by the smart device to be displayed on a display screen of the smart device, providing the desired view of external surroundings. The smart device is removably attached to the bicycle such that the smart device display screen is visible to the rider when the rider is in a substantially horizontal riding position on the bicycle. In one aspect, the mirror is positioned at an angle relative to the plane of the smart device in the range of 35 degrees to 55 degrees.

In one aspect the relative positions of minor, smart device and bicycle are arranged such that the camera receives light arriving at the minor from external surroundings in front of the bicycle, the desired view being a forward view. In another aspect, the relative positions of minor, smart device and bicycle are arranged such that the camera receives light arriving at the minor from external surroundings behind the bicycle, the desired view being a rear view.

### BRIEF DESCRIPTION OF THE DRAWINGS

FIG. 1 illustrates operational concepts of a viewing system according to one embodiment.

FIG. 2 illustrates operational concepts of a viewing system according to another embodiment.

FIG. 3A is a schematic side view of a viewing system according to one embodiment.

FIG. 3B is a photographic image of a viewing system according to another embodiment.

FIG. 4 is a schematic side view of a viewing system with an integrated mirror according to one embodiment.

FIG. 5 is a schematic view of the implementation of a viewing system on a bicycle according to one embodiment.

### DETAILED DESCRIPTION

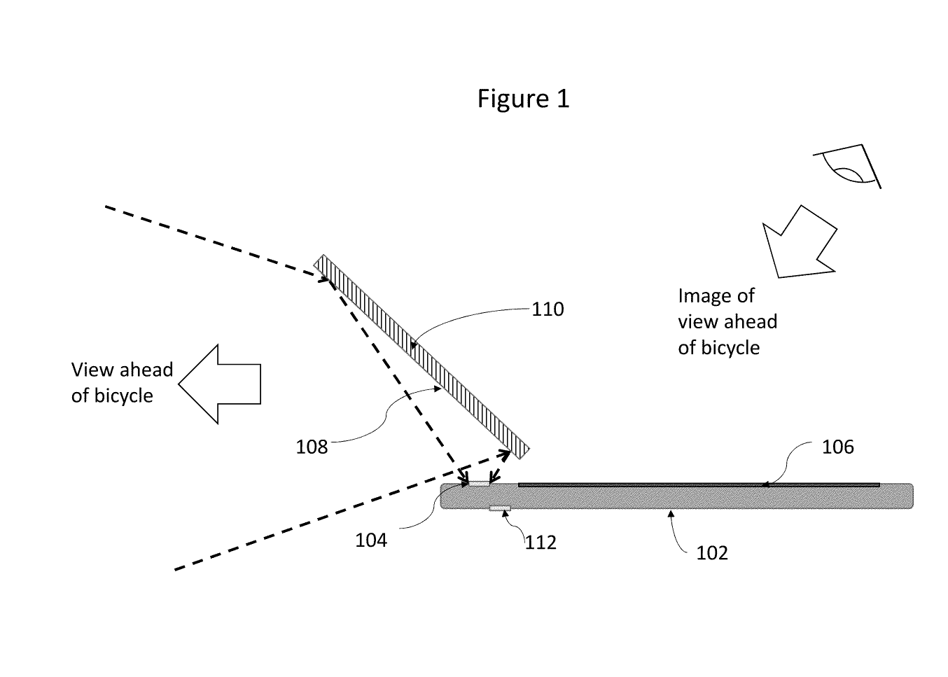

The manner in which the present invention provides its advantages can be more easily understood with reference to FIGS. 1 through 5. In the following discussion, the term “smartphone” is generally used for convenience and simplicity, but it should be understood that a tablet, mini-tablet or other similar smart device may be used, rather than a smartphone, without departing from the spirit of the invention.

FIG. 1 illustrates some operational concepts of a viewing system according to one embodiment, in which minor 110 with reflecting surface 108 is positioned at an angle to smartphone 102, such that light received from the left hand side of the figure and reflected off reflecting surface 108 is incident on the optical system of camera 104. Camera 104 is simply the camera included as a standard option within smartphone 102, positioned on the same front surface of smartphone 102 as the smartphone display screen 106. Display screen 106 may be viewed by the rider, represented by the symbol of an eye at the top right hand side of the figure. In this embodiment, the smartphone is operated in a manner that displays images captured by camera 104 on display screen 106, allowing the rider, looking downwards at screen 106, to view the environment that would normally only be visible if the rider's head were rotated through a substantial angle (approximately 45 degrees in a clockwise direction in the case shown). Camera 112, positioned to capture light from the field of view beneath the smartphone, may also be included within smartphone 102, and is shown in the figure for completeness, but is not significant in this embodiment.

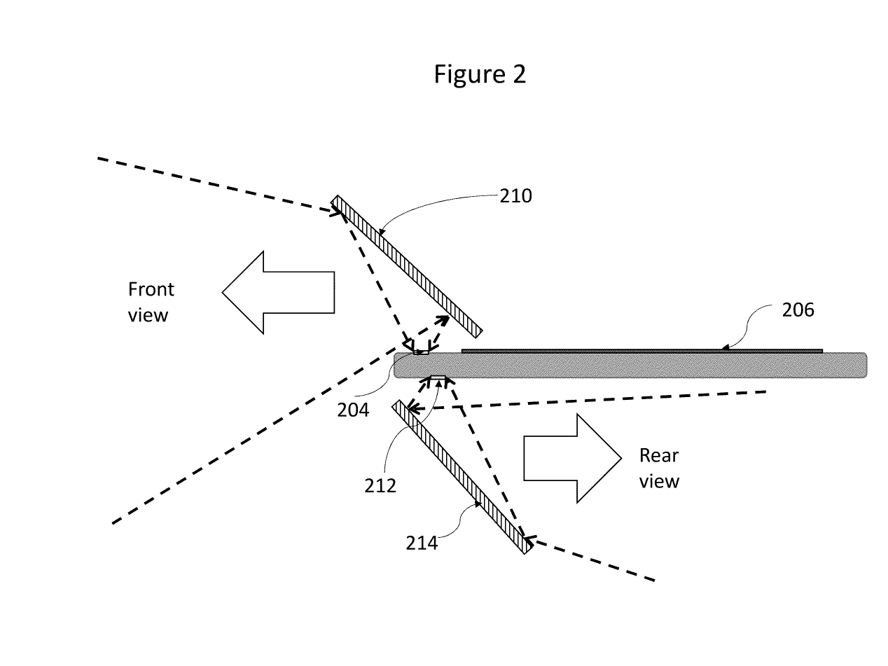

FIG. 2 illustrates operational concepts of a viewing system according to another embodiment, in which both front facing (204) and rear facing (212) cameras are utilized. In this case, mirror 210 reflects light from the scene in front of the bicycle (left hand side of figure) onto camera 204, while minor 214 reflects light from the scene behind the bicycle (right hand side of figure) onto camera 212. Either one of the images provided by camera 204 or 214, or both of the images may be displayed on screen 206.

In some embodiments, the position and orientation of either or both of mirrors 210 and 214 may be altered so that, for example, minor 210 reflects light from the scene behind the bicycle onto camera 204, or minor 214 reflects light from the scene in front of the bicycle onto camera 212.

As demonstrated by the embodiments of FIGS. 1 and 2, the present invention relies on the use of a smartphone to capture and display images in a very convenient way. Many road bicycle riders already use their smartphones to help monitor riding progress and follow predetermined riding routes via satellite mapping as well as to provide general support such as playing music, displaying alerts etc. These smartphones may be mounted on the road bicycle on or around the area of the handlebars or handlebar stem, in some cases on the main bicycle frame itself. This invention makes use of such a smartphone, in its simplest embodiments simply adding and suitably, securely positioning one or more minors so that the minor or minors in coordination with the smartphone camera can provide the additional feature of conveniently and comfortably viewing the terrain ahead, or behind, or in some other direction relative to the bicycle.

In those cases where the rider's smartphone only has a single camera present, that camera being present on the opposite face of the smartphone to the display screen, as is mirror 212 of FIG. 2, it may still be possible to obtain a forward view on the smartphone display screen. In one such case (not shown) the angle and position of a forward facing mirror would be set differently from the position shown in FIG. 2 for minor 210, the mirror being rotated by about 90 degrees in the clockwise direction, and displaced to the lower side of the smartphone, so that light from the scene ahead would be directed onto the single, downward facing camera. Other arrangements are possible, in which one or more additional minors are positioned to direct the light from a single forward facing minor such as minor 210 of FIG. 2 around the left hand edge of the smartphone to reach the single camera on the lower surface of the smartphone.

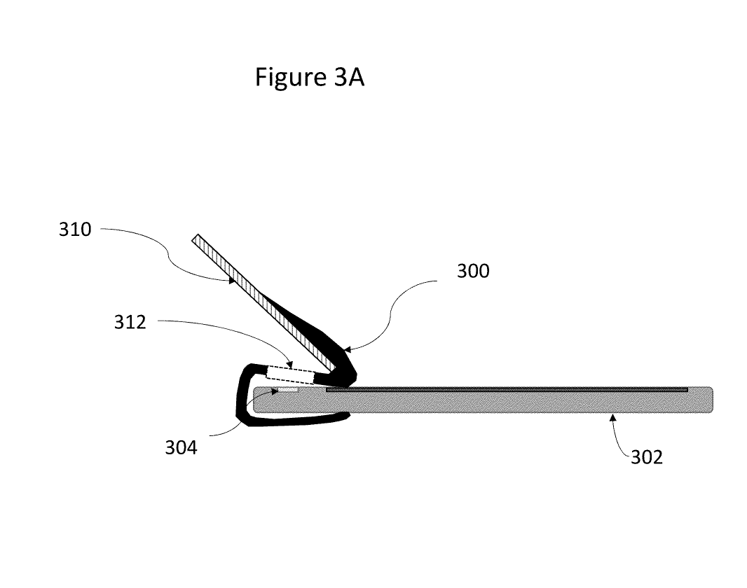

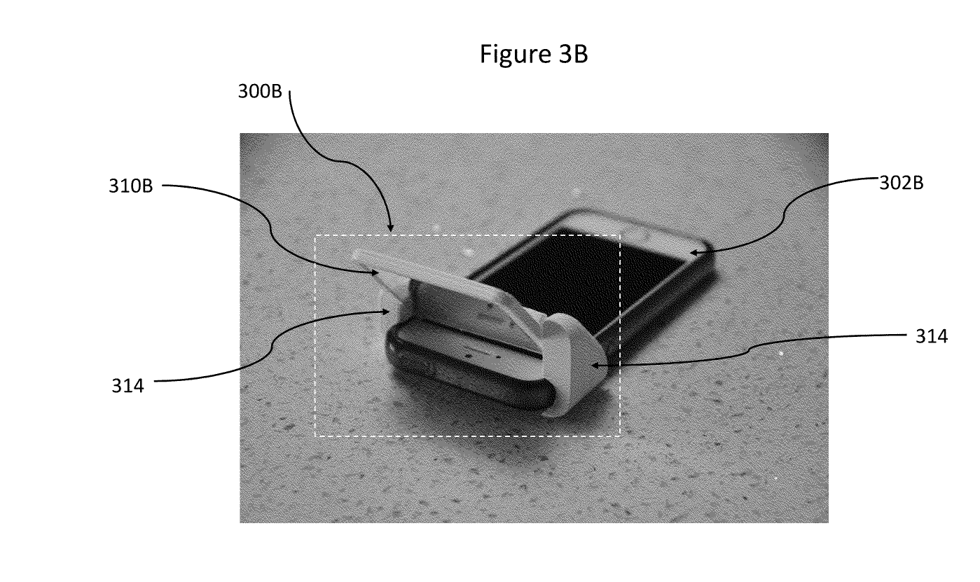

FIG. 3A is a schematic side view of a viewing system comprising a clip 300, onto the upper portion of which minor 310 is attached by glue or mechanical means. The clip may be a simple piece of sheet metal, bent to shape in a double curve as shown. The front, reflecting surface of mirror 310 is minimally if at all obstructed by the upper portion of clip 300. In some cases, grooves on the front (left hand) surface of the upper portion of clip 300 may allow minor 310 to be simply slid into place. Smartphone 302 can be similarly slid or press fit into a lower portion of clip 300, as shown, with aperture 310, which may be a simple hole punched into the sheet metal, allowing light to pass substantially unobstructed from minor 310 to camera 304.

FIG. 3B shows a photographic image of a viewing system 300B comprising a housing into which are integrated minor 310B and two side clamps 314 that clamp around the sides of smartphone 302B.

In the embodiments of FIGS. 3A and 3B, clip 300 is envisaged to be used in conjunction with an existing smartphone cradle, clamp or mounting system (not shown), already designed to hold a smartphone and attach to a bicycle, without requiring any modification to allow for the presence of the clip and minor. In other cases, to be described in detail below, a smartphone holder and a bicycle mounting apparatus specifically designed for the present invention may be used, offering additional advantages of stability, customization etc.

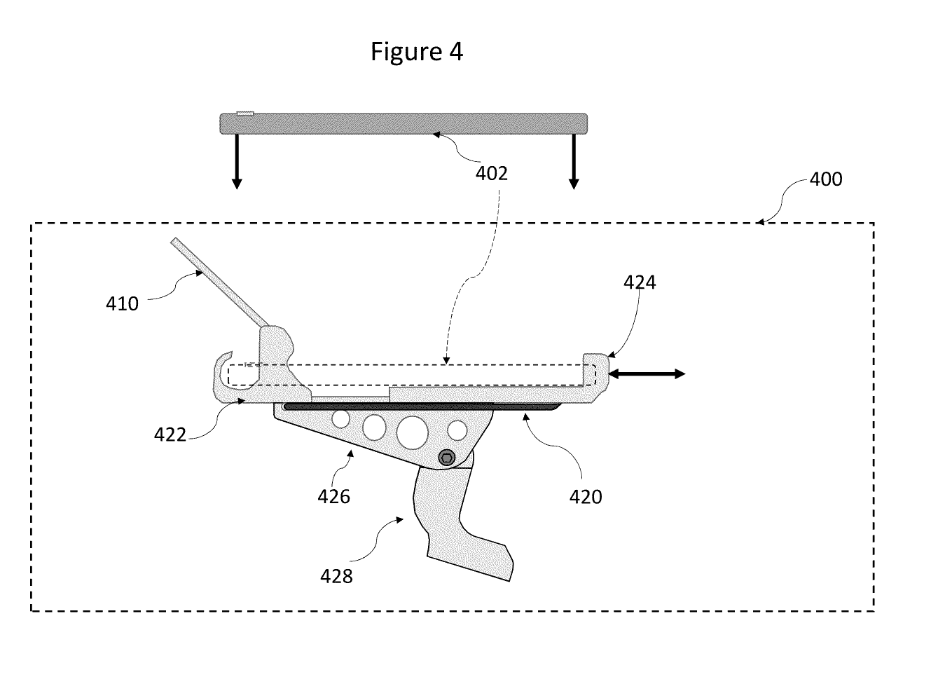

FIG. 4 is a schematic side view of a viewing system 400 with integrated mirror 410 according to one embodiment. In this case, the minor is oriented at a fixed position of approximately 45 degrees to the horizontal. The mirror will typically be a plane mirror, but in some embodiments the mirror may include some curvature, a convex mirror, for example, providing a wider field of view.

Mirror 410 may be attached to first carrier 422 of system 400 by a press fit, by sliding into a groove, by a clip, by one or more screws or bolts, by an adhesive, or by using any other type of appropriate mechanical attachment. Either or both of the minor and the carrier could be fabricated of metal or a plastic composite. In some cases, a process such as injection molding may be used to fabricate a single piece including both carrier 422 and minor 410 as an integrated whole. In other embodiments, the mirror may include a reflector embedded in a flat frame, the flat frame allowing for more convenient mechanical attachment to carrier 422.

In some embodiments, the minor angle may be adjustable, by, for example, using a hinge or other pivoting means within first carrier 422 of system 400. First carrier 422 is designed and configured to be fixed to second carrier 424 and ultimately to lower plate 428 which in turn is designed to be reversibly attached to the bicycle, typically to the main ribs or lower frame, using any of a standard range of attachment mechanisms such as clamps, bolts etc. In the case shown, first carrier 422 attaches directly to upper plate 426, which in turn attaches to lower plate 428. In some embodiments, the combination of minor 410, first carrier 422, and upper plate 426 may be fabricated as a single piece, using, for example, an injection molding technique.

Second carrier 424 of system 400 contains a cradle, cavity or receptacle into which a smartphone such as smartphone 402 may be inserted. The length of the cavity may be adjusted as indicated by the double headed arrow on the right hand side of the figure to allow smartphones of different sizes to be accommodated. In some cases, the adjustment may be automatic; in others, some manual adjustment input by the rider may be necessary. Once the smartphone is in position, as indicated by the dashed outline, lower position of smartphone 402 in FIG. 4, it must be held securely in that position, so that motion of the bicycle does not destabilize the image capture and display. One relatively simple, automatic method of carrying out the adjustment and secure hold is to use a bungee cord or a spring-restored slidable housing or lower mount, as shown in FIG. 4, but other well-known mechanical methods, for example involving clips or clamps, may be envisaged. Alternatively, in some embodiments, the dimensions of second carrier 424 may be fixed, while first carrier 422 may include an adjustable mechanism to accommodate smartphones of different dimensions.

Lower plate 428 of system 400 may take the rough form of a boot as shown in FIG. 4, with a “leg” or post and a “foot”, where the foot includes a hole allowing plate 428 to be bolted into the handlebar stem of the bicycle, or attached thereto by some other strong, secure method. Alternatively, the foot of 428 may be replaced by a structure comprised of a clamping mechanism (not shown) so that 428 can be clamped onto the handlebars or the bicycle or similar area on the bicycle. Upper plate 426 of system 400 includes a means of adjusting the vertical level of second carrier 424 relative to lower plate 428. In some embodiments, this adjustment may be carried out with the use of one or more hinge mechanisms within upper plate 426 that pivots around, or is hinged in turn to, lower plate 428. Many other ways to adjust the vertical level of system 400 relative to the bicycle using hinges or other mechanical features in the upper or lower plates or the first and second carriers may be envisaged.

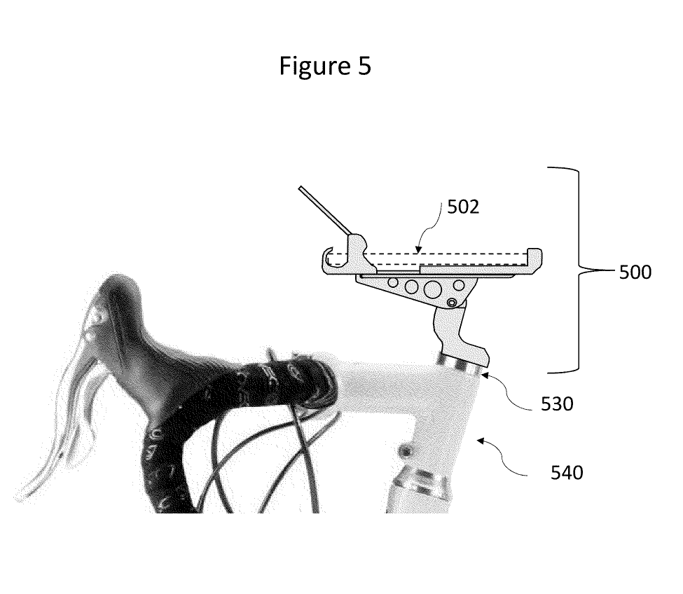

FIG. 5 is a schematic view of the implementation of a viewing system 500 mounted on bicycle 540 according to one embodiment. Only a small portion of bicycle 540 is shown for simplicity. System 500 is attached to the handlebar stem 530 of bicycle 540. Smartphone 502 is held approximately horizontally as shown, and at a vertical height set so that the rider looking downwards may comfortably view its display screen. The mirror integrated into system 500 is positioned so that light from the scene ahead of the bicycle is directed onto a camera (not shown) on the top surface of smartphone 502, providing the rider with a view of that scene on the display screen.

The manner in which the images captured by the camera or cameras of the smartphones may be analyzed before or after they are directed to the display screen, as snapshots or video streams, will not be discussed in detail in this application. It may however be envisaged that smartphone applications will be developed that take advantage of captured images of the surrounding environment to provide even greater value to the horizontally positioned road bicycle rider than by providing a simple real-time raw image stream.

In some embodiments, the relative positioning and orientation of the mirror or minors and the camera or cameras will allow the standard image handling and processing application already present in the smart phone to be used without any modification being necessary. In other cases, it may be necessary to add appropriate image processing to invert the captured image in order to present a “true” image on the display screen, easily interpreted by the rider.

In this application, the term “configured to” is defined to mean that the structural element recited before the term has a size, shape, and in some cases, additional features that are structured by design such that the action recited after the term is inherently enabled. For example, stating that the first carrier of a system “is configured to securely hold a mirror” is a compact way of saying that the first carrier has the right size and shape and mechanical integrity to hold a mirror and also includes one or more features that make the hold a secure one, rather than, for example, simply providing a flat surface against which the mirror may be rested. Secure holding is obviously important in the application of interest to this invention, so that a stable image may be provided even though the bicycle is in motion.

Similarly, the statement that a receptacle is configured to securely and reversibly hold a smartphone is a compact way of saying that the receptacle has the right size and shape and mechanical integrity to hold a smartphone, and also includes features that allow the smartphone to be easily removed and reinserted. In the application of interest to this invention, the rider will typically want to use their normal smartphone for all its normal purposes before and after the bicycle ride in which it is used for its forward or rear view image provision as described above, so simple insertion and removal are necessary features. The slidable base and bungee cord arrangement described above provide one solution, but others may be envisaged such as using a spring in place of the bungee, or including a built-in spring design into the manufacturing process for the receptacle. Alternatively, the assembly may not have an automatic arrangement, the carriers instead being secured by means of a bolt and a winged nut or other quick clamping mechanisms to fix the carriers in place after positioning the second carrier to secure the smartphone in place.

Embodiments described herein provide various benefits. In particular, some embodiments utilize a standard smartphone and a standard smartphone-bicycle mount, probably already in the possession of the rider, adding a small, simple minor apparatus that can be easily and securely attached to the smartphone and (indirectly) to the bicycle, to enable a bicycle rider in a horizontal riding position to be able to see a view of the environment in front of the bicycle, without having to raise their head. Other embodiments utilize just a standard smartphone, adding a mirror apparatus, a smartphone carrier, and a bicycle mount apparatus to attach the combination to the bicycle, again enabling a bicycle rider in a horizontal riding position to be able to see a view of the environment in front of the bicycle, without having to raise their head. In either case, the comfort and safety of the rider is significantly enhanced. Other embodiments may provide similar advantages by additionally or alternately providing views of the environment in other directions.

As noted above in the first paragraph of the “Detailed Description” section, other embodiments of the present invention may use tablets, mini-tablets, or other similar devices rather than the smartphones referred to in the bulk of the discussion for the sake of simplicity.

The above-described embodiments should be considered as examples of the present invention, rather than as limiting the scope of the invention. Various modifications of the above-described embodiments of the present invention will become apparent to those skilled in the art from the foregoing description and accompanying drawings. Accordingly, the present invention is to be limited solely by the scope of the following claims.

1. A method of presenting a desired view of external surroundings to a rider of a bicycle, the method comprising:
attaching a minor to a smart device at a position and orientation relative to a camera integrated into the smart device such that light from external surroundings incident on the mirror is reflected onto the camera; and
activating an application on the smart device causing images captured by the smart device to be displayed on a display screen of the smart device, providing the desired view of external surroundings to the rider viewing the display screen;
wherein the smart device is removably attached to the bicycle such that the smart device display screen is visible to the rider when the rider is in a substantially horizontal riding position on the bicycle.

2. The method of claim 1 wherein the smart device is a smartphone.

3. The method of claim 1 wherein the mirror is positioned at an angle relative to the plane of the smart device in the range of 35 degrees to 55 degrees.

4. The method of claim 1 wherein the relative positions of mirror, smart device and bicycle are arranged such that the camera receives light reflected downwards from the mirror, the desired view being a forward view of external surroundings in front of the bicycle.

5. The method of claim 1 wherein the relative positions of mirror, smart device and bicycle are arranged such that the camera receives light reflected upwards from the minor, the desired view being a rear view of external surroundings behind the bicycle.

6. An apparatus that provides a desired view of external surroundings to a rider of a bicycle, the apparatus comprising:
a first carrier configured to securely hold a minor;
a second carrier comprising a receptacle configured to securely and reversibly hold a smart device; and
an upper plate attached to the first and second carriers, and configured to securely and reversibly attach to the bicycle;
wherein the mirror position and angular orientation relative to the smart device, when the minor is held by the first carrier and when the smart device is held by the second carrier, cause light from external surroundings incident on the mirror to be reflected onto a camera integrated into the smart device; and
wherein the smart device display screen, when the smart device is held by the second carrier and the upper plate is attached to the bicycle, is visible to the rider when the rider is in a substantially horizontal riding position on the bicycle.

7. The apparatus of claim 6 wherein the first carrier includes an adjustment mechanism controlling at least one of the angle and position of the minor.

8. The apparatus of claim 6 wherein the minor is positioned at an angle relative to the plane of the smart device in the range of 35 degrees to 55 degrees.

9. The apparatus of claim 6 wherein the minor is integrated into the first carrier of the apparatus.

10. The apparatus of claim 6 wherein the first carrier is configured to allow convenient insertion and removal of a mirror.

11. The apparatus of claim 6 additionally comprising an aperture positioned between the mirror and the camera.

12. The apparatus of claim 6 wherein the second carrier includes an adjustable member that allows any one of a plurality of smart devices of different sizes to be securely and reversibly held by the second carrier.

13. The apparatus of claim 12 wherein the adjustable member comprises a bungee cord.

14. The apparatus of claim 6 wherein the upper plate comprises a lower portion configured to securely and reversibly attach to the handlebar stem of the bicycle

15. The apparatus of claim 6 wherein the upper plate comprises an upper portion configured to securely and reversibly attach to the main ribs of the smart device cradle 400.

16. The apparatus of claim 6 wherein the relative positions of mirror, smart device and bicycle are arranged such that the camera receives light reflected downwards from the minor, the desired view being a forward view of external surroundings in front of the bicycle.

17. The apparatus of claim 6 wherein the relative positions of mirror, smart device and bicycle are arranged such that the camera receives light reflected upwards from the mirror, the desired view being a rear view of external surroundings behind the bicycle.

18. The apparatus of claim 6 additionally comprising an adjustment mechanism configured to allow the rider to adjust the vertical position of the second carrier relative to the upper plate.

19. The apparatus of claim 6 wherein the smart device is a smartphone.

20. An apparatus that provides a desired view of external surroundings to a rider of a bicycle, the apparatus comprising:
a carrier comprising a mirror, the carrier being configured to securely and reversibly attach to a smart device configured to be securely and reversibly held by a smart device carrier, the smart device carrier being configured to securely and reversibly attach to the bicycle;
wherein the mirror position and angular orientation relative to the smart device held by the smart device carrier cause light from external surroundings incident on the minor to be reflected onto a camera integrated into the smart device; and
wherein the smart device display screen, when the smart device is held by the smart device carrier and when the smart device carrier is attached to the bicycle, is visible to the rider when the rider is in a substantially horizontal riding position on the bicycle.
